(19) United States
(12) Patent Application Publication
(10) Pub. No.: US 2025/0347829 A1
(43) Pub. Date: Nov. 13, 2025

(54) OPTICAL ELEMENT, OPTICAL DEVICE, SYSTEM, AND METHOD FOR MANUFACTURING OPTICAL ELEMENT

(71) Applicant: CANON KABUSHIKI KAISHA, Tokyo (JP)

(72) Inventor: RYOTA KOYAMA, Kanagawa (JP)

(21) Appl. No.: 19/198,866

(22) Filed: May 5, 2025

(30) Foreign Application Priority Data
May 8, 2024 (JP) 2024-075623

(51) Int. Cl. G02B 5/04; G02B 27/01

(52) U.S. Cl. CPC G02B 5/04; G02B 27/0172; G02B 2027/0178

(57) ABSTRACT

An optical element includes a first molded part made of resin and a second molded part made of resin and configured to cover at least a part of the first molded part. The first molded part has a recess. The second molded part has a first resin part having an optical surface on an outer surface and a second resin part having a non-optical surface on an outer surface. A gate mark in molding the first molded part is disposed in the recess and covered with the second resin part.

### BACKGROUND

### Technical Field

The present technology relates to a resin-made optical element including a prism, a method for manufacturing the same, and the like.

### Description of the Related Art

An optical prism is an optical element having optical functions such as refraction, dispersion, and total reflection, and generally has a polyhedral shape thicker than an optical lens or the like in many cases. As a method for manufacturing the optical prism, a method for manufacturing the optical prism by injection molding using a thermoplastic resin is known. When the optical prism is manufactured by injection molding, a mold having a space (cavity) corresponding to the polyhedral shape of the optical prism is used, and the molten resin is filled in the cavity and then cooled and solidified, whereby a resin prism can be obtained.

Since a resin material as a raw material of the optical prism and a metal material constituting the mold have a large difference in thermal conductivity, a temperature distribution is likely to occur in the resin when the resin injected into the cavity is cooled and solidified. In particular, since a thick shape such as an optical prism has a large heat capacity, it is difficult to promptly release a heat in a central portion to the mold. When the temperature distribution is generated in the resin in the step of solidification, a strain tends to remain inside the formed resin prism. Here, a state in which a strain remains refers to a state in which density of the solidified resin becomes uneven depending on a location and a refractive index distribution is generated. Note that presence or absence of the strain can be inspected by, for example, transmission wavefront measurement that is non-destructive inspection. When the strain remaining inside is large, the refractive index distribution becomes remarkable, and optical characteristics of the resin prism are deteriorated.

Japanese Patent Application Laid-Open No. 2023-145037 discloses a technique of molding a first molded part with a first mold, then setting the first molded part in a second mold, and injection-molding the second molded part outside the first molded part to produce a prism. It has been proposed that a thick prism shape is formed in two portions to reduce the capacity of the molten resin per one portion, thereby reducing the temperature distribution in the step of solidifying the molten resin and suppressing occurrence of internal strain.

According to the method described in Japanese Patent Application Laid-Open No. 2023-145037, the thick-shaped prism is formed in two portions to reduce the capacity of the molten resin per one portion, thereby suppressing the occurrence of internal strain to some extent.

However, when the first molded part is molded using the first mold in order to manufacture an optical element having a thick shape, the internal strain tends to easily occur around a specific portion in the first molded part. If the internal strain remains around the specific portion of the first molded part even after the second molded part is molded, and the internal strain is a portion corresponding to an optical path inside the optical element, the optical characteristics of the optical element may be adversely affected.

### SUMMARY

According to a first aspect of the present disclosure, an optical element includes a first molded part made of resin and a second molded part made of resin and configured to cover at least a part of the first molded part. The first molded part has a recess. The second molded part has a first resin part having an optical surface on an outer surface and a second resin part having a non-optical surface on an outer surface. A gate mark in molding the first molded part is disposed in the recess and covered with the second resin part.

According to a second aspect of the present disclosure, a method for manufacturing an optical element includes a step of injecting a molten resin from a first gate of a first mold provided with the first gate and a first cavity into the first cavity and solidifying the molten resin to form a first molded part having a recess in which a gate mark of the first gate is disposed, and a step of disposing the first molded part in a second cavity of a second mold provided with a second gate and the second cavity, injecting a molten resin from the second gate into the second cavity and solidifying the molten resin to form a second molded part that covers at least a part of the first molded part. The second mold includes a first molding surface that forms at least one optical surface molded in the second molded part, and a second molding surface that forms at least one non-optical surface molded in the second molded part. In the step of forming the second molded part, the first molded part is disposed in the second cavity such that the gate mark of the first gate faces the second molding surface across a part of a space of the second cavity, and the molten resin is injected into the space.

Further features of the present disclosure will become apparent from the following description of exemplary embodiments with reference to the attached drawings.

### BRIEF DESCRIPTION OF THE DRAWINGS

FIG. 1A is a perspective view of an upper surface side of an optical prism according to an embodiment.

FIG. 1B is a perspective view of a lower surface side of the optical prism according to the embodiment.

FIG. 2A is a plan view of the optical prism according to the embodiment.

FIG. 2B is a side view of the optical prism according to the embodiment.

FIG. 3A is a schematic cross-sectional view of the optical prism taken along line I-I in FIG. 2A.

FIG. 3B is a schematic cross-sectional view of the optical prism taken along line II-II in FIG. 2A.

FIG. 4A is a schematic cross-sectional view of the optical prism taken along line II-III in FIG. 2A.

FIG. 4B is a schematic cross-sectional view of the optical prism taken along line IV-IV in FIG. 2A.

FIG. 5A is a perspective view of a first molded part as obliquely viewed from above.

FIG. 5B is a perspective view of the first molded part as obliquely viewed from below.

FIG. 6A is a plan view of the first molded part.

FIG. 6B is a side view of the first molded part.

FIG. 7 is a schematic cross-sectional view for describing a structure of a mold (first mold) used for manufacturing the first molded part.

FIG. 8A is a view illustrating a state in which the mold is opened.

FIG. 8B is a view illustrating a state in which the mold is clamped.

FIG. 8C is a view illustrating an injection step.

FIG. 9A is a view illustrating a cooling step.

FIG. 9B is a view illustrating a mold opening step.

FIG. 9C is a view illustrating a releasing step.

FIG. 10 is a schematic cross-sectional view for describing a structure of a mold (second mold) used for manufacturing a second molded part.

FIG. 11A is a view illustrating a state in which the mold is opened.

FIG. 11B is a view illustrating a state in which the mold is clamped.

FIG. 11C is a view illustrating an injection step.

FIG. 12A is a view illustrating a state in which the mold is opened.

FIG. 12B is a view illustrating a state in which the mold is clamped.

FIG. 12C is a view illustrating an injection step.

FIG. 13A is a view illustrating a cooling step.

FIG. 13B is a view illustrating a mold opening step.

FIG. 13C is a view illustrating a releasing step.

FIG. 14A is an external perspective view of a head mounted display according to an embodiment.

FIG. 14B is an external perspective view of the head mounted display according to the embodiment as viewed from a different direction.

FIG. 14C is a schematic diagram illustrating a state in which a user wears the head mounted display.

FIG. 15A is a block diagram illustrating a configuration of the head mounted display according to the embodiment.

FIG. 15B is a schematic diagram illustrating an MR system according to an embodiment.

### DESCRIPTION OF THE EMBODIMENTS

A resin-made optical prism according to an embodiment of the present technology, a method for manufacturing the same, and the like will be described with reference to the drawings. The embodiments to be described below are examples, and for example, detailed configurations can be appropriately changed and implemented by those skilled in the art without departing from the gist of the present technology. In the drawings referred to in the following description of the embodiments, elements denoted by the same reference numerals have similar functions unless otherwise specified. Further, each of an X direction, a Y direction, and a Z direction illustrated in the drawings indicates a direction parallel to a coordinate axis of an orthogonal coordinate system. Note that, since the drawings to be referred to may be schematically represented for convenience of illustration and description, the drawings do not strictly coincide with actual shape, size, arrangement, and the like.

### Overview

In an embodiment, injection molding is performed in two stages in order to suppress a residual strain inside a resin-made optical prism. First, a first molded part, which is made of resin, serving as a core material of the optical prism is injection-molded using a first mold. The cooled first molded part is set in a cavity of a second mold, a molten resin is injected from a gate into the cavity, and a second molded part is injection-molded outside the first molded part. A molding surface (transfer surface) of a second mold includes an optical surface transfer region for forming an optical surface on the second molded part and a non-optical surface transfer region for forming a non-optical surface. According to the present embodiment, a thick prism shape is formed in two portions to reduce the capacity of the molten resin per one portion, thereby reducing the temperature distribution in the step of solidifying the molten resin and suppressing occurrence of internal strain.

When the first molded part is injection-molded, the molten resin is injected from a first gate into a cavity of the first mold, and a molded product is taken out from the first mold after solidification. Then, the first molded part having a first gate mark that is a trace of the first gate is obtained by cutting off a runner solidified portion from the taken molded product. In general, since the first molded part has a relatively large thickness, it is necessary to relatively increase a molding pressure applied from the first gate into the cavity. Therefore, a large internal stress tends to remain around a specific portion of the first molded part, that is, around the first gate mark. The internal stress remaining around the first gate mark of the first molded part extends to a portion immediately below a position covered with the optical surface of the second molded part later and a portion that is not immediately below the optical surface but serves as an optical path in the optical prism, and thus the internal stress may adversely affect optical characteristics of the optical prism as it is.

In the present embodiment, the cavity of the second mold is configured such that the first gate mark of the first molded part is covered with the injected molten resin when the first molded part is inserted into the cavity of the second mold and the second molded part is injection-molded. By adopting this configuration, a periphery of the first gate mark of the first molded part is covered with the molten resin flowing in forming the second molded part and heated, and the residual internal stress (internal strain) is significantly reduced by an annealing effect. That is, it is possible to significantly reduce the internal stress distributed over the entire first molded part by bringing the first gate mark in which the large internal stress remains in the first molded part and the periphery thereof into contact with the molten resin and annealing the first molded part and the periphery thereof when the second molded part is molded. As a result, the thick optical element including the first molded part and the second molded part can exhibit excellent optical characteristics because the internal strain of the portion serving as the optical path inside is reduced and surface accuracy of the optical surface is improved.

### EMBODIMENTS

### Form of Optical Prism

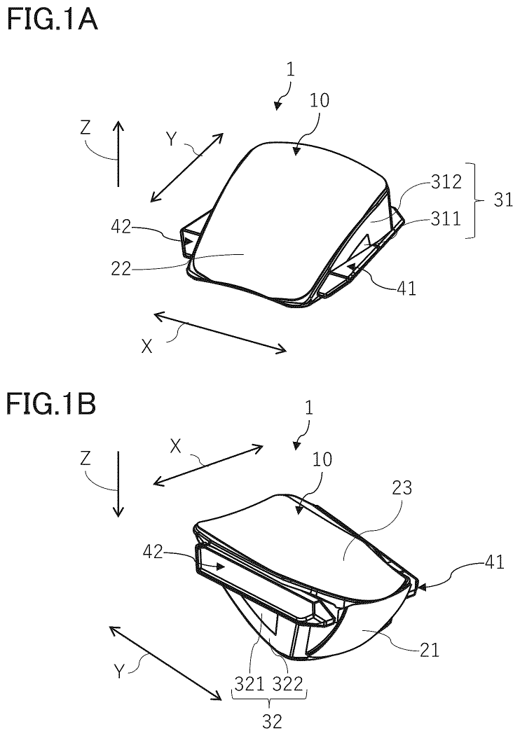

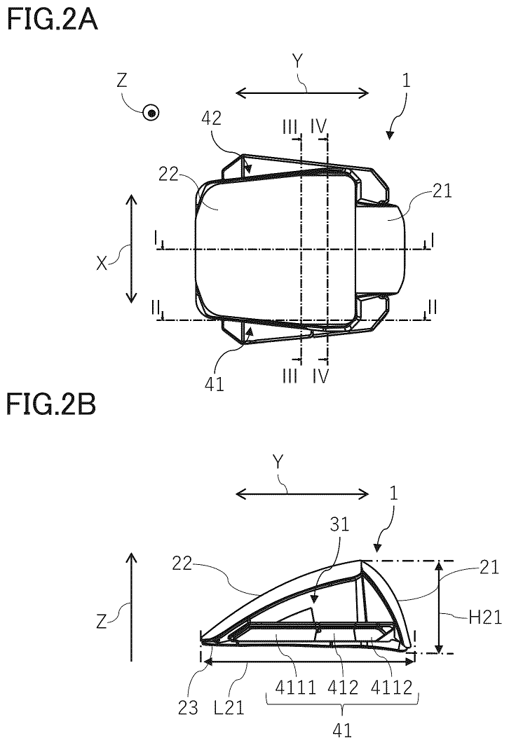

FIGS. 1A and 1B are perspective views of an optical prism 1 as an example of an optical element according to the present embodiment as viewed from different directions. FIG. 1A is a perspective view of an upper surface side of the optical prism 1, and FIG. 1B is a perspective view of a lower surface side of the optical prism 1. Further, FIG. 2A is a plan view of the optical prism 1 according to the present embodiment, and FIG. 2B is a side view of the optical prism 1 according to the present embodiment.

The optical prism 1 is a resin optical component having a plurality of optical surfaces and at least one non-optical surface. A thermoplastic resin is preferably used as a raw material of the optical prism 1. Among the thermoplastic resins, it is preferable to use a cycloolefin polymer, a cycloolefin copolymer, polycarbonate, or acrylic.

The optical prism 1 includes a prism body 10 that is a portion optically acting on a light beam, and a protrusion 41 and a protrusion 42 that are positioned and fixed to a support member of an optical device (not illustrated) when the optical prism 1 is attached to the optical device. The prism body 10 is a polyhedron having a function to refract, disperse, or totally reflect light, and is an optical member thicker than an optical lens such as a convex lens, a concave lens, or an aspherical lens. The protrusion 41 and the protrusion 42 are disposed so as to protrude to both sides of the prism body 10 along an X-axis direction.

The optical prism 1 has a first optical surface 21, a second optical surface 22, and a third optical surface 23. The first optical surface 21 can be used as an incident surface (incident refractive surface) of a light beam. The second optical surface 22 can be used as a total internal reflection surface. The third optical surface 23 can be used as an exit surface (exit refractive surface) of the light beam. Each optical surface is desirably configured as a surface having high flatness with surface roughness Ra of less than 20 nm. The surface roughness Ra of each surface can be measured using, for example, a white interferometer Newview8300 manufactured by ZYGO.

A portion of an outer surface of the optical prism 1 excluding the above-described three optical surfaces includes the non-optical surface. A side surface 31 that is the non-optical surface and a side surface 32 that is the non-optical surface are disposed at positions that are seen when the optical prism 1 is viewed along the X direction. The side surface 31 is connected to each of the first optical surface 21, the second optical surface 22, and the third optical surface 23. The side surface 32 located on the opposite side of the side surface 31 is also connected to each of the first optical surface 21, the second optical surface 22, and the third optical surface 23. Further, a surface of the protrusion 41 protruding in the X direction from the side surface 31 and a surface of the protrusion 42 protruding in the X direction from the side surface 32 are also the non-optical surfaces.

The protrusion 41 includes a projection 4111 and a projection 4112 of a first molded part 11 and a projection 412 of a second molded part 12, and surfaces of these projections are the non-optical surfaces. Further, the protrusion 42 includes a projection 421 of the first molded part 11, and a surface thereof is the non-optical surface. Note that the protrusion 41 and the protrusion 42 can function as supported parts supported by a device when the optical prism 1 is fixed to the device. The protrusion 41 and the protrusion 42 may include only the first molded part, may include both the first molded part and the second molded part, or may include only the second molded part. However, considering that the protrusion is useful for inserting the first molded part into the mold and positioning the first molded part when molding the second molded part, at least a part of the protrusion 41 and the protrusion 42 desirably includes the first molded part.

Since the non-optical surface of the outer surface of the optical prism 1 is not a region irradiated with an effective light flux when the optical prism 1 is used, the non-optical surface may be a surface having lower flatness than the optical surface. For example, the non-optical surface may be configured as a rough surface having the surface roughness Ra of 50 nm or more. Note that the non-optical surface may be a surface having high flatness similarly to the optical surface.

### Structure of Optical Prism

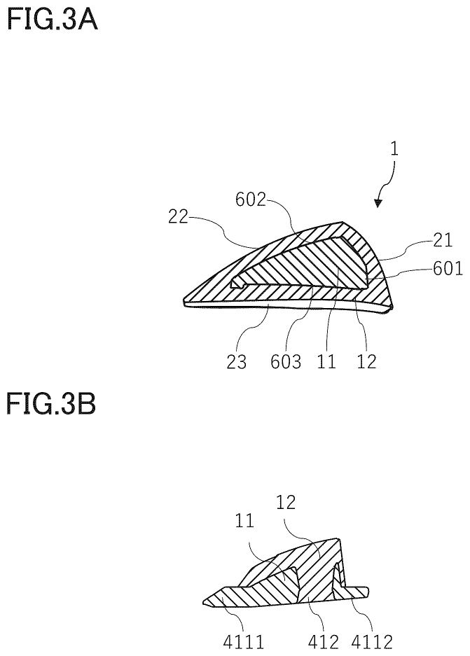

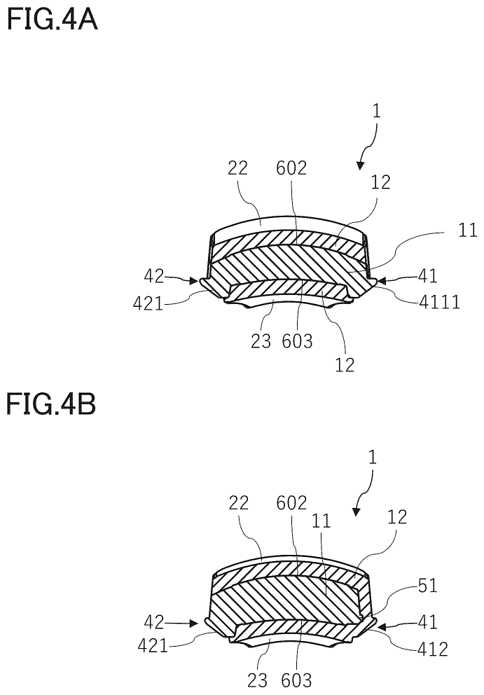

Next, a structure of the optical prism 1 will be described. FIG. 3A is a schematic cross-sectional view of the optical prism 1 taken along line I-I in FIG. 2A, and FIG. 3B is a schematic cross-sectional view of the optical prism 1 taken along line II-II in FIG. 2A. Further, FIG. 4A is a schematic cross-sectional view of the optical prism 1 taken along line III-III in FIG. 2A, and FIG. 4B is a schematic cross-sectional view of the optical prism 1 taken along line IV-IV in FIG. 2A.

As illustrated in each cross-sectional view, the optical prism 1 has a structure in which the first molded part 11 and the second molded part 12 are integrated. The first molded part 11 is a core material of the optical prism 1, and the second molded part 12 covers at least a part of the first molded part. In the second molded part 12, a portion where an optical surface is formed on an outer surface is referred to as a first resin part, and a portion where the non-optical surface is formed on the outer surface is referred to as a second resin part.

As illustrated in FIG. 3A, the first optical surface 21, the second optical surface 22, and the third optical surface 23 are formed on an outer surface of the optical prism 1. The first optical surface 21, the second optical surface 22, and the third optical surface 23 are disposed on the outer surface of the second molded part 12. In an interface between the first molded part 11 and the second molded part 12, a portion immediately below the first optical surface 21 is referred to as a first optical interface 601 for convenience. Similarly, in the interface between the first molded part 11 and the second molded part 12, a portion immediately below the second optical surface 22 is referred to as a second optical interface 602, and a portion immediately below the third optical surface 23 is referred to as a third optical interface 603. The first optical interface 601 to the third optical interface 603 can be located on an optical path through which a light beam passes in the optical prism 1. Note that the interface between the first molded part 11 and the second molded part 12 can be checked by cutting the optical prism 1 to prepare a thin sample, polishing the surface and performing physical and chemical treatment, and observing a crystal structure and a trace of a resin flow by optical microscope observation.

The side surface 31 of the optical prism 1 illustrated in FIG. 1A includes a partial outer surface 311 of the first molded part 11 and a partial outer surface 312 of the second molded part 12. Further, as illustrated in FIG. 2B, the protrusion 41 includes the projection 4111 and the projection 4112 that are a part of the first molded part 11, and the projection 412 that is a part of the second molded part 12.

The side surface 32 of the optical prism 1 illustrated in FIG. 1B includes a partial outer surface 321 of the first molded part 11 and a partial outer surface 322 of the second molded part 12. Further, the protrusion 42 includes the projection 421 that is a part of the first molded part 11.

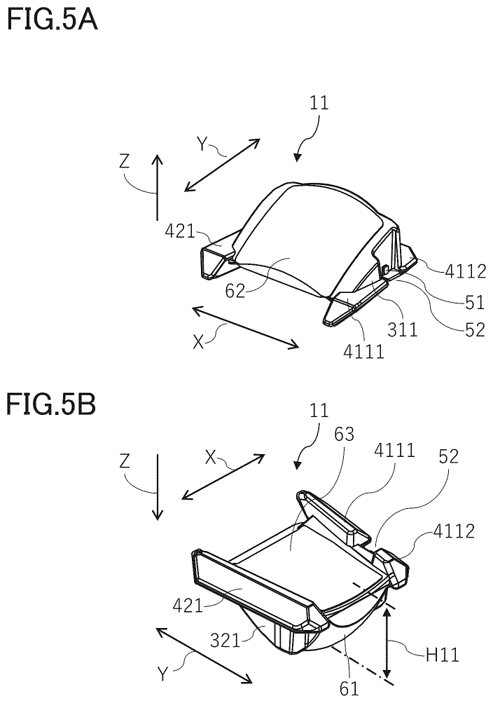

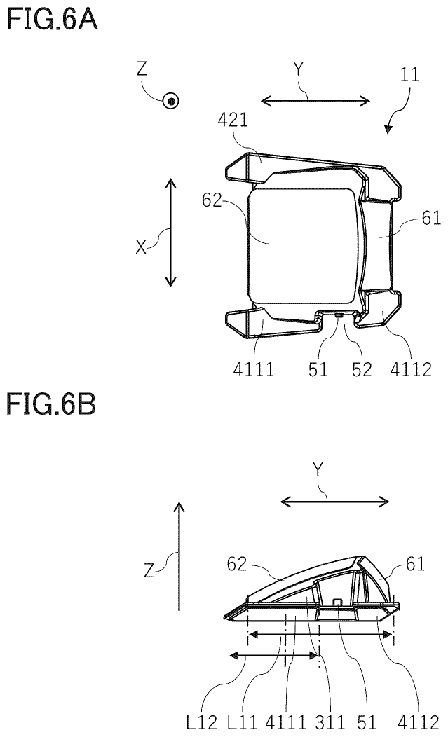

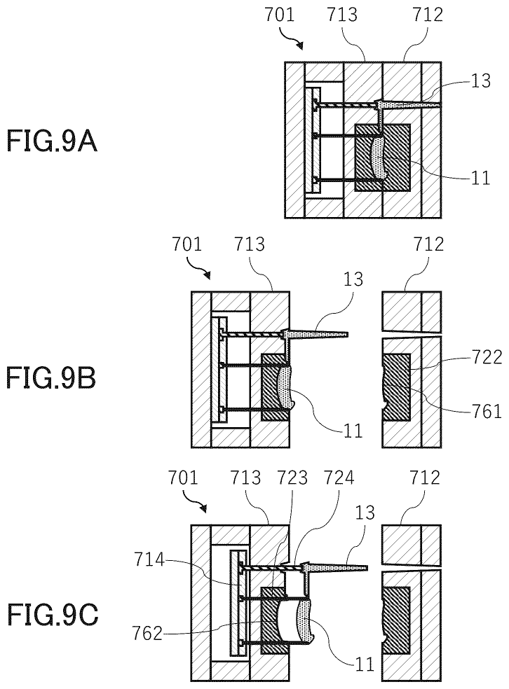

To facilitate understanding of a shape of the first molded part 11 that is the core material, a diagram in which only the portion of the first molded part 11 is extracted is illustrated below. FIG. 5A is a perspective view of the first molded part 11 as obliquely viewed from above, and FIG. 5B is a perspective view of the first molded part 11 as obliquely viewed from below. FIG. 6A is a plan view of the first molded part 11, and FIG. 6B is a side view of the first molded part 11. These drawings illustrate the shape of the first molded part 11 obtained by releasing the molded product from a mold 701 as illustrated in FIG. 9C and then cutting off a runner solidified portion 13 in a manufacturing step to be described below.

In FIGS. 5A to 6B, a region coming into contact with the second molded part 12 at the first optical interface 601 in the outer surface of the first molded part 11 is illustrated as a first optical corresponding surface 61. Similarly, a region coming into contact with the second molded part 12 at the second optical interface 602 is illustrated as a second optical corresponding surface 62, and a region coming into contact with the second molded part 12 at the third optical interface 603 is indicated as a third optical corresponding surface 63.

The first molded part 11 includes the projection 421, the projection 4111, and the projection 4112 each projecting in the X direction. The projection 421 constitutes the protrusion 42 of the optical prism 1 (FIG. 1A). The projection 4111 and the projection 4112 are disposed at intervals in the Y direction, and each constitutes a part of the protrusion 41 of the optical prism 1.

In the first molded part 11, if a portion separating the projection 4111 and the projection 4112 is referred to as the recess 52, the first gate mark 51 is formed in the recess 52. Although a method for manufacturing the first molded part 11 will be described below, the first gate mark 51 is a mark of a gate 751 left in the first molded part 11 after the runner solidified portion 13 is cut off from the molded product molded by injecting the molten resin into the cavity of the mold 701.

In the optical prism 1 that is a finished product, the first gate mark 51 is covered with the projection 412 that is a part of the second molded part 12, as illustrated in FIG. 4B. Although the first gate mark 51 is not exposed on the outer surface of the optical prism 1 because it is covered with the projection 412 that is a part of the protrusion 41 (FIG. 2B), it can be confirmed that the first gate mark 51 exists at that position by measuring a birefringence inside the optical prism 1. Note that the birefringence can be measured using, for example, a two-dimensional birefringence evaluation system WPA-200 manufactured by Photonic Lattice.

Next, a preferred example of dimensions of each part of the optical prism 1 will be described. A length L21 in a Y-axis direction of the optical prism 1 illustrated in FIG. 2B is 27.4 mm, and a thickness H21 in a Z-axis direction is 11.9 mm. A width of the optical prism 1 in the X-axis direction is 25.0 mm. A thickness H11 of the first molded part 11 in the Z-axis direction illustrated in FIG. 5B is 7.4 mm. A length L11 of the portion serving as the core material of the prism body 10 in the Y-axis direction illustrated in FIG. 6B is 17.9 mm. Alength L12 of the projection 4111 forming the protrusion 41 in the Y-axis direction is 11.9 mm. A distance between the projection 4111 and the projection 4112 in the Y-axis direction, that is, the length of the projection 412 in the Y-axis direction is 4.5 mm, and the width W of the protrusion 41 in the X-axis direction is 2.3 mm. Each of the distance between the first optical surface 21 and the first optical interface 601, the distance between the second optical surface 22 and the second optical interface 602, and the distance between the third optical surface 23 and the third optical interface 603 illustrated in FIG. 3A is within a range of 1.5 mm or more and 1.8 mm or less. This corresponds to the thickness of the second molded part 12 in the portion where the optical surface is formed. Note that the above dimensions are examples, and it goes without saying that the present embodiment is not limited thereto.

### Method for Manufacturing Optical Prism

Next, a method for manufacturing the optical prism 1 will be described. First, a method for manufacturing the first molded part 11 that is a core material (core part) will be described, and next, a method for manufacturing the second molded part 12 that covers at least a part of the first molded part 11 will be described.

### Method for Manufacturing First Molded Part

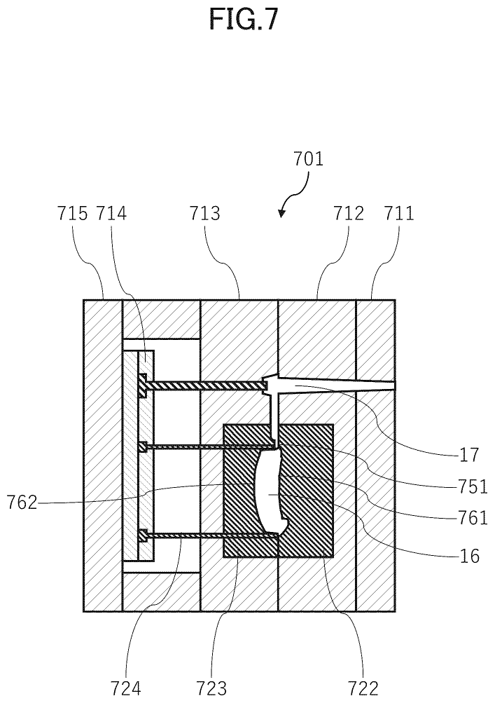

FIG. 7 is a schematic cross-sectional view for describing a structure of the mold 701 (first mold) used for manufacturing the first molded part 11. FIG. 7 illustrates the mold 701 in a clamped state, and a cavity 16 (first cavity) for forming the first molded part 11 is defined inside the clamped mold 701.

The mold 701 has a fixed-side mounting plate 711, a fixed-side retainer plate 712, a movable-side retainer plate 713, an ejector plate 714, and a movable-side mounting plate 715. A runner space 17 is defined by the fixed-side mounting plate 711, the fixed-side retainer plate 712, and the movable-side retainer plate 713.

A fixed-side core 722 is attached to the fixed-side retainer plate 712. A movable-side core 723 is attached to the movable-side retainer plate 713. The fixed-side core 722 has a fixed-side first molding surface 761 that molds (transfers) the shapes of the third optical corresponding surface 63, the projection 4111, a part of the projection 4112, and a part of the protrusion 42. The movable-side core 723 has a movable-side first molding surface 762 that forms (transfers) the shapes of the first optical corresponding surface 61, the second optical corresponding surface 62, the partial outer surface 311, the partial outer surface 321, the projection 4111, the projection 4112, and the recess 52. The ejector plate 714 has a plurality of ejector pins 724, and tips of the ejector pins 724 are exposed to the cavity 16 and the runner space 17. The molten resin is injected from the runner space 17 into the cavity 16 through the first gate 751.

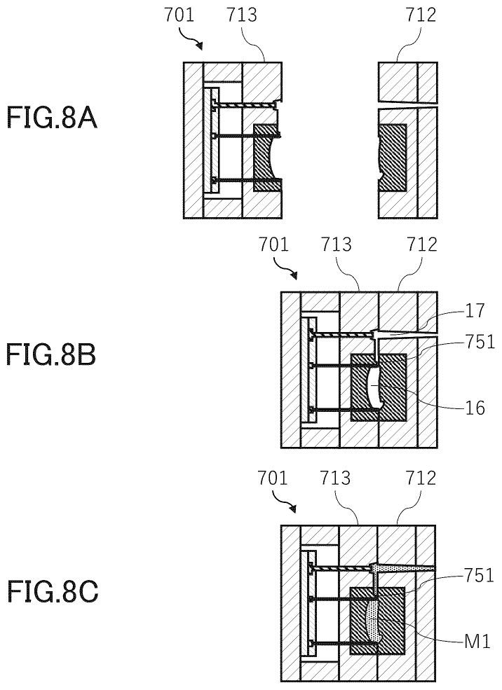

FIGS. 8A to 8C and FIGS. 9A to 9C are schematic views for describing steps of the method for manufacturing the first molded part 11 according to the first embodiment.

As illustrated in FIG. 8A, molding is started from a state in which the mold 701 is opened. Next, in a mold clamping step illustrated in FIG. 8B, the mold 701 is clamped. At this time, the fixed-side retainer plate 712 and the movable-side retainer plate 713 come into contact with each other, and the cavity 16 and the runner space 17 are defined in the mold 701.

Next, in an injection step illustrated in FIG. 8C, a molten resin M1 is injected into the cavity 16 through the runner space 17 and the first gate 751 by an injection machine (not illustrated).

Next, in a cooling step illustrated in FIG. 9A, by setting the temperature of the mold 701 to a predetermined temperature lower than the glass transition temperature of the resin, the molten resin M1 is cooled and solidified to form the first molded part 11 and the runner solidified portion 13. The mold 701 is, for example, a water-cooled type, and is cooled to the predetermined temperature by water.

After the first molded part 11 is sufficiently cooled, the mold 701 is opened in a mold opening step illustrated in FIG. 9B. At this time, the first molded part 11 molded in the cavity 16 and the runner solidified portion 13 solidified in the runner space 17 are separated from the fixed-side core 722.

Next, in a releasing step illustrated in FIG. 9C, the ejector plate 714 is advanced toward the fixed-side retainer plate 712, and the ejector pin 724 is protruded from the movable-side core 723. With this operation, the first molded part 11 and the runner solidified portion 13 are separated from the movable-side first molding surface 762 of the movable-side core 723. That is, the first molded part 11 and the runner solidified portion 13 connected to the first molded part 11 are released from the mold 701.

Thereafter, in a runner cutting step (not illustrated), the runner solidified portion 13 is detached and separated from the first molded part 11. At this time, the first gate mark 51 remains in the first molded part 11. Through the above steps, the first molded part 11 is manufactured.

The first molded part 11 has the outer shape described with reference to FIGS. 5A to 6B, but since the first molded part 11 has a relatively large thickness, a molding pressure applied from the first gate 751 into the cavity 16 is relatively large. Therefore, a relatively large internal stress remains around the gate mark in the internal space of the first molded part 11.

### Method for Manufacturing Second Molded Part

Next, a method for manufacturing the second molded part 12, that is, a step of covering at least a part of the first molded part 11 with the second molded part 12 to complete the optical prism 1 will be described.

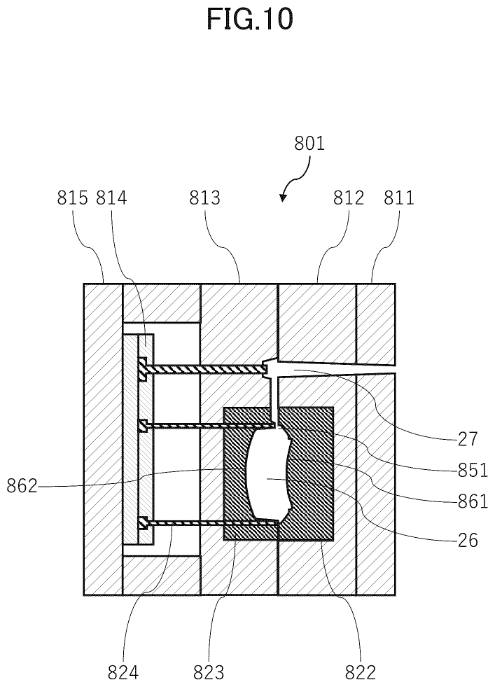

FIG. 10 is a schematic cross-sectional view for describing a structure of a mold 801 (second mold) used for manufacturing the second molded part 12. FIG. 10 illustrates the mold 801 in a clamped state. Although not illustrated in FIG. 10, in molding, the first molded part 11 is inserted into the mold 801 in advance and the mold is clamped, whereby a cavity 26 (second cavity) for molding the second molded part 12 is defined on the first molded part 11.

The mold 801 has a fixed-side mounting plate 811, a fixed-side retainer plate 812, a movable-side retainer plate 813, an ejector plate 814, and a movable-side mounting plate 815. A runner space 27 is defined by the fixed-side mounting plate 811, the fixed-side retainer plate 812, and the movable-side retainer plate 813.

A fixed-side core 822 is attached to the fixed-side retainer plate 812. A movable-side core 823 is attached to the movable-side retainer plate 813. The fixed-side core 822 has a fixed-side second molding surface 861 that molds (transfers) the shape of the third optical surface 23. The movable-side core 823 has a movable-side second molding surface 862 that molds (transfers) the shapes of the first optical surface 21 and the second optical surface 22. To form a high-performance optical surface, it is desirable that the surface roughness Ra of the fixed-side second molding surface 861 and the movable-side second molding surface 862 is less than 20 nm.

The ejector plate 814 has a plurality of ejector pins 824, and tips of the ejector pins 824 are exposed to the cavity 26 and the runner space 27. The molten resin is injected from the runner space 27 into the cavity 26 through the second gate 851.

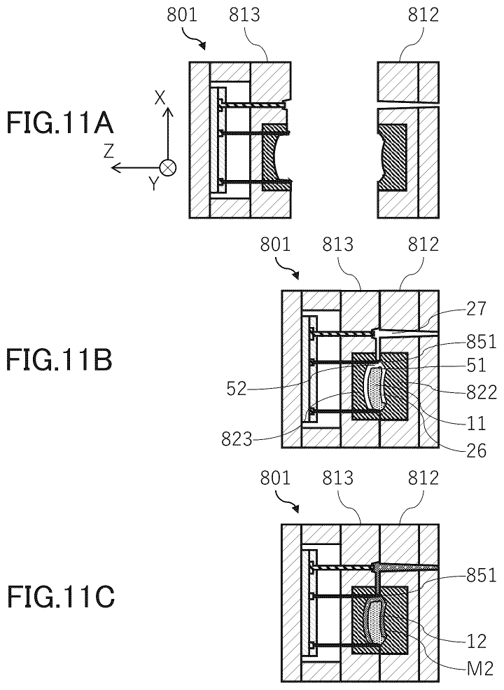

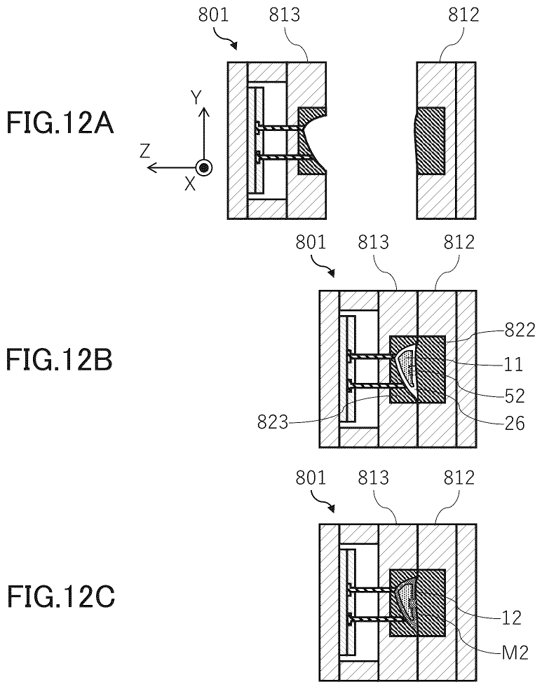

FIGS. 11A to 11C, FIGS. 12A to 12C, and FIGS. 13A to 13C are schematic cross-sectional views for describing steps of the method for manufacturing the second molded part 12 according to the first embodiment. Note that FIGS. 11A to 11C illustrate a cross section of the mold 801 cut along an XZ plane, and FIGS. 12A to 12C illustrate a cross section of the mold 801 cut along a YZ plane.

As illustrated in FIGS. 11A and 12A, molding is started from a state in which the mold 801 is opened. Next, the mold clamping step illustrated in FIGS. 11B and 12B is performed. Hereinafter, the mold clamping step will be described in detail.

First, the molded first molded part 11 is heated to a temperature close to the temperature of the mold 801, and is disposed (inserted) at a predetermined position in the cavity 26 of the opened mold 801. At this time, the recess 52 of the first molded part 11 and the second gate 851 of the mold 801 are disposed to face each other with a space therebetween.

Next, the mold 801 is clamped. At this time, the fixed-side retainer plate 812 and the movable-side retainer plate 813 come into contact with each other in the state where the first molded part 11 is inserted in the mold 801, and the cavity 26 (second cavity) and the runner space 27 are defined. The projection 4111, the projection 4112, and the projection 421 of the first molded part 11 are sandwiched between the fixed-side core 822 and the movable-side core 823, whereby the first molded part 11 is accurately positioned and fixed in the cavity 26.

Next, in an injection step illustrated in FIGS. 11C and 12C, a molten resin M2 is injected into the cavity 26 through the runner space 27 and the second gate 851 by an injection machine (not illustrated). The material of the molten resin M1 used to form the first molded part 11 and the material of the molten resin M2 used to form the second molded part 12 are desirably substantially the same. Here, “substantially the same” means the same except for industrially unavoidable differences that occur when the molten resin is manufactured.

In the present embodiment, the first molded part 11 is inserted into the mold 801 such that a space is formed between the first gate mark 51 (or the recess 52) of the first molded part 11 and the gate (or the molding surface for molding the non-optical surface) of the mold 801. Since the molten resin M2 is injected into this space, the first gate mark 51 (or the recess 52) and the periphery thereof are heated, and a sufficient annealing effect can be obtained for a portion where a relatively large internal stress remains in the first molded part 11.

For example, if the glass transition point temperature of the resin of the first molded part 11 is 140° C. and the temperature of the injected molten resin M2 is 250° C. to 300° C., the first gate mark 51 (or the recess 52) and the periphery thereof can be annealed at a temperature higher than the glass transition point temperature. Further, if the temperature of the molten resin M2 to be injected is equal to or higher than a melting point of the resin of the first molded part 11, the first gate mark 51 (or the recess 52) and a part of the periphery thereof can be melted and mixed with the molten resin M2. As described above, even in a case where the annealing treatment is performed at a temperature higher than a melting point temperature of the resin of the first molded part 11, a relatively large internal stress remaining in the first molded part 11 can be significantly reduced.

For example, amorphous and crystalline cycloolefin polymers are known as cycloolefin polymers used as materials for optical elements. In a case where an amorphous resin material is used as the material of the first molded part 11, it is desirable to perform the annealing treatment at a temperature equal to or higher than the glass transition point temperature, and in a case where a crystalline resin material is used, it is desirable to perform the annealing treatment at a temperature equal to or higher than the melting point.

Although the first gate mark 51 is not exposed on the outer surface of the optical prism 1 because it is covered with the second molded part 12, it can be confirmed that the first gate mark exists at the position by measuring the birefringence inside the optical prism 1. Even in a case where the first gate mark 51 is deformed or melted by the annealing treatment, it can be confirmed that the first gate mark 51 exists at the position by measuring the birefringence inside the optical prism 1. Note that the birefringence can be measured using, for example, a two-dimensional birefringence evaluation system WPA-200 manufactured by Photonic Lattice. Further, the position at which the first gate mark 51 exists can also be confirmed by observing a portion having a large birefringence by an orthogonal Nicol method.

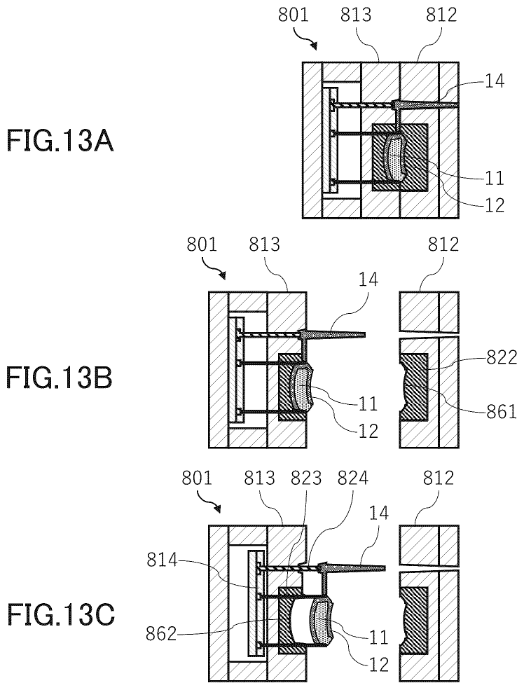

When the filling of the molten resin M2 is completed in the injection step, the cooling step shown in FIG. 13A is performed. In the cooling step, by setting the temperature of the mold 801 to a predetermined temperature lower than the glass transition temperature of the resin, the molten resin M2 is cooled and solidified to form the second molded part 12 solidified in the cavity 26 and a runner solidified portion 14 solidified in the runner space 27. The mold 801 is, for example, a water-cooled type, and is cooled to the predetermined temperature by water.

After the second molded part 12 is sufficiently cooled, the mold 801 is opened in the mold opening step illustrated in FIG. 13B. At this time, the second molded part 12 integrated with the first molded part 11 and the runner solidified portion 14 are separated from the fixed-side core 822.

Next, in the releasing step illustrated in FIG. 13C, the ejector plate 814 is advanced toward the fixed-side retainer plate 812, and the ejector pin 824 is protruded from the movable-side core 823. As a result, the second molded part 12 integrated with the first molded part 11 and the runner solidified portion 14 are separated from the movable-side second molding surface 862 of the movable-side core 823. As a result, the second molded part 12 integrated with the first molded part 11 and the runner solidified portion 14 connected to the second molded part 12 are released from the mold 801.

Thereafter, in the runner cutting step (not illustrated), the runner solidified portion 14 is detached and separated from the second molded part 12. At this time, the second gate mark that is a trace of the second gate 851 remains in the second molded part 12. Through the above steps, the optical prism 1 is manufactured.

In the present embodiment, since the optical prism 1 is manufactured by performing the injection molding twice, the thickness of the resin body molded by each injection molding can be reduced, and the time required for cooling can be shortened. Since a cooling time exponentially increases as the thickness of the resin body increases, a sum of the time required for the injection molding of the first molded part 11 and the second molded part 12 is shorter than the time required if the optical prism 1 is manufactured by one injection molding. That is, by manufacturing the optical prism 1 by performing the injection molding twice, productivity of the optical prism 1 is improved.

Furthermore, since the thickness of the resin body molded by each injection molding can be reduced as compared with the case of manufacturing a thick optical element in one injection step, a molding pressure required in the step of filling the cavity with the resin can be reduced. Therefore, the internal stress of the resin of the optical prism 1 can be made relatively small.

Furthermore, according to the present embodiment, the periphery of the first gate mark 51 of the first molded part 11 in which a relatively large internal stress remains is covered with and heated by the molten resin M2 that has flowed in, and the residual internal stress (internal strain) is significantly reduced by the annealing effect. As a result, the internal stress distributed over the entire first molded part 11 is significantly reduced, and the internal strain of the portion serving as the optical path inside the optical prism is reduced. Therefore, it is possible to provide an optical prism having extremely excellent optical characteristics.

### Optical Device Including Optical Prism

The optical device according to the embodiment will be described by taking a head mounted display (hereinafter “HMD”) including the above-described optical prism 1 as an example. Note that, in the following description, letters L and R at the end of the reference numerals indicate components of optical units for the left eye and the right eye.

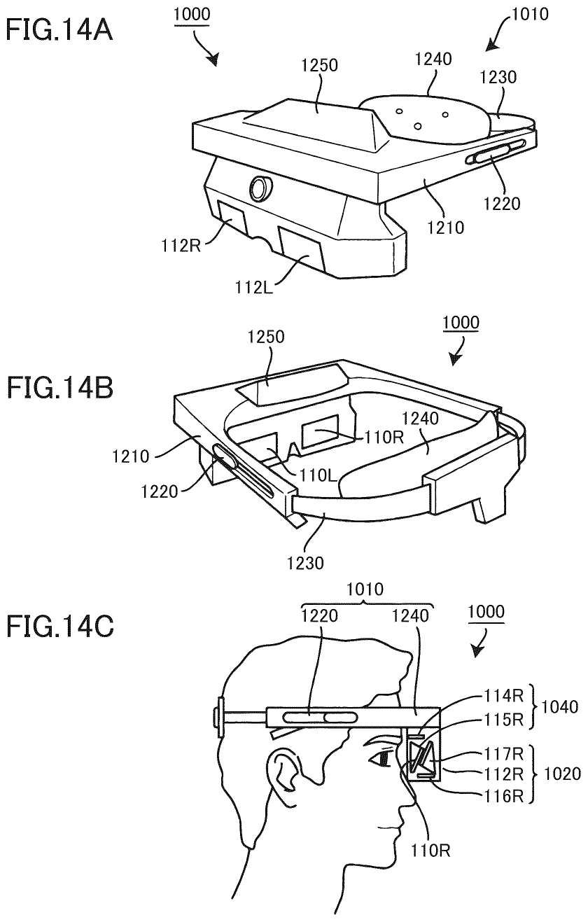

FIGS. 14A and 14B are external perspective views of an HMD 1000 according to the present embodiment as viewed from different directions. In addition, FIG. 14C is a schematic view illustrating a state in which a user wears the HMD and illustrates an optical mechanism corresponding to the right eye, but an optical mechanism with L added to the end of the reference numeral is disposed on the left eye side (not illustrated).

The HMD 1000 includes a head mounting unit 1010 for mounting the HMD 1000 on the head of the user, an imaging unit 1020 that captures a video of front of the head of the user, and a display unit 1040 that displays graphics.

The head mounting unit 1010 is for mounting the HMD 1000 of the present embodiment to the head of the user, and includes a temporal mounting part 1210, an adjuster 1220, a length adjusting part 1230, an occipital mounting part 1240, and a forehead mounting part 1250.

To mount the HMD 1000 to the head, first, the user wears the HMD on the head with the length adjusting part 1230 loosened by the adjuster 1220. Then, after the forehead mounting part 1250 is brought into close contact with the forehead, the adjuster 1220 tightens the length adjusting part 1230 so that the temporal mounting part 1210 and the occipital mounting part 1240 are brought into close contact with a temporal region and an occipital region, respectively. Note that, as the head mounting unit 1010, various types such as a spectacle frame type and a helmet type can be used in addition to a goggle type illustrated in the drawing.

The imaging unit 1020 is a so-called digital camera, and includes entrance windows 112L and 112R, imaging sensors 116L and 116R, and optical prisms 117L and 117R according to the above-described embodiment. The imaging unit 1020 captures an image in substantially the same direction (direction corresponding to a field of view of the user) as a direction in which the head of the user wearing the HMD 1000 of the present embodiment faces. Specifically, light incident from an outside of the HMD through the entrance windows 112L and 112R is guided into the HMD 1000 by the optical prisms 117L and 117R, and is received and imaged by the imaging sensors 116L and 116R. The optical prisms 117L and 117R according to the embodiment are positioned and fixed to a casing (a support member that supports the optical prisms) of the HMD 1000 with the protrusion 41 and the protrusion 42 as attachment parts, respectively.

The display unit 1040 includes screens 110L and 110R, color liquid crystal displays 114L and 114R, and optical prisms 115L and 115R according to the above-described embodiment. The display unit 1040 is provided at a position corresponding to spectacle lenses in spectacles so as to face the positions of the user's eyes. Specifically, images displayed by the color liquid crystal displays 114L and 114R are guided by the optical prisms 115L and 115R and displayed on the screens 110L and 110R. The optical prisms 115L and 115R according to the embodiment are positioned and fixed to the casing of the HMD 1000 with the protrusion 41 and the protrusion 42 as attachment parts, respectively.

In a case where the HMD 1000 is a video see-through type, the screens 110L and 110R do not have transmittance in principle, and display light from the color liquid crystal displays 114L and 114R guided by the optical prisms 115L and 115R is displayed as it is. Meanwhile, in a case where the HMD 1000 is a glass see-through type, the screens 110L and 110R are configured by so-called half mirrors. That is, the screens 110L and 110R have constant transmittance, and the user can optically see a scene in a real space. At the same time, the color liquid crystal displays 114L and 114R are displayed by a mirror embedded on a front surface, a back surface, or inside, and the display light of graphics guided by the optical prisms 115L and 115R is reflected in the direction of the user's eyes. That is, in the case of the glass see-through type, the scene in the real space and an image (graphics) of a virtual object are optically superimposed on the screens 110L and 110R.

Output light of the optical prisms 115L and 115R of the display unit 1040 and input light of the optical prisms 117L and 117R of the imaging unit 1020 coincide with optical axes of the pupils of the user, and the imaging sensors 116L and 116R capture the video of the real space in the position of the user and the direction of the head.

In the case of the video see-through type HMD, an image obtained by electrically superimposing (synthesizing) the video of the real space captured by the imaging sensors 116L and 116R and the image (graphics) of the virtual object is displayed on the color liquid crystal displays 114L and 114R. Meanwhile, in the case of the glass see-through type HMD, in principle, only the image (graphics) of the virtual object is displayed on the color liquid crystal displays 114L and 114R.

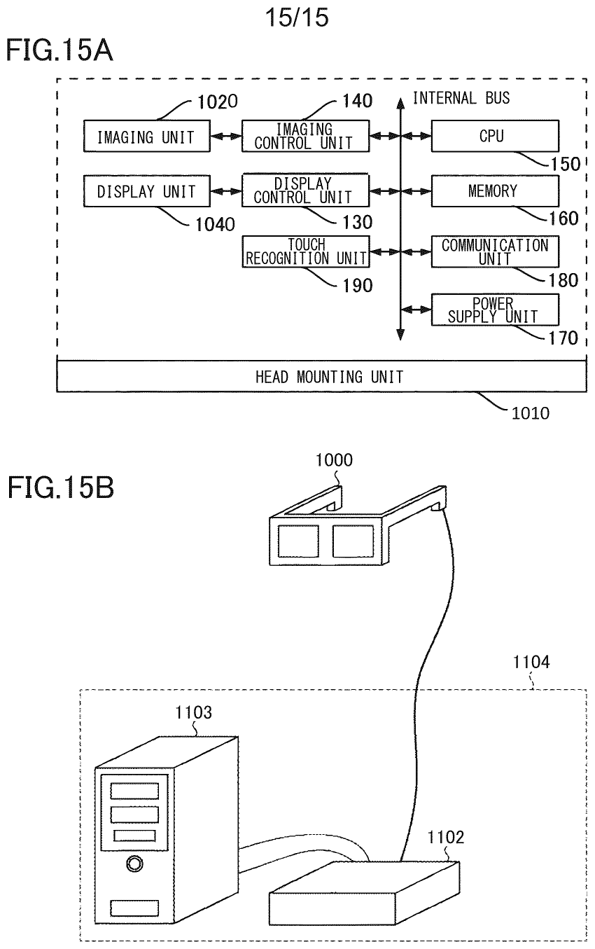

FIG. 15A is a block diagram illustrating a configuration of the HMD 1000 according to the present embodiment. The HMD 1000 further includes a display control unit 130, an imaging control unit 140, a CPU 150, a memory 160, a power supply unit 170, a communication unit 180, and a touch recognition unit 190, which are embedded in a main body including the head mounting unit 1010 and are not illustrated in FIGS. 14A to 14C.

The display control unit 130 performs display control of the display unit 1040. For example, a size, a position, a direction, a color, and transparency of the image (graphics) of the virtual object to be superimposed and displayed (synthesized) on the video of the real space, movement and a change in brightness accompanying a change in the video of the real space, and the like are controlled. The image of the virtual object includes, for example, images of a graphical user interface such as a menu display for inputting a user's instruction, a keyboard, and the like.

The imaging control unit 140 performs exposure control, distance measurement control, and the like on the basis of a calculation result by predetermined calculation processing using imaging data. As a result, autofocus (AF) processing, automatic exposure (AE) processing, automatic white balance (AWB) processing, and the like are performed. Furthermore, in a case where the imaging unit 1020 includes a mechanism for inserting and removing an optical filter into and from the optical path, an anti-vibration mechanism, and the like, control of insertion and removal of the filter, anti-vibration, and the like is performed according to the imaging data and other conditions.

The CPU 150 performs arithmetic processing of the entire HMD 1000. Each processing of the present embodiment is implemented by executing a program recorded in the memory 160 to be described below. The memory 160 includes a work area and a nonvolatile area. A program, and constants and variables for system control read from the nonvolatile area are expanded in the work area in the memory 160. Furthermore, data of the image (graphics) of the virtual object to be superimposed and displayed in the real space is held for display. Furthermore, captured data captured by the imaging unit 1020 and subjected to A/D conversion is held for the purpose of image analysis, image processing, or the like.

The power supply unit 170 includes a primary battery such as an alkaline battery or a lithium battery, a secondary battery such as a NiCd battery, a NiMH battery, or a Li battery, an AC adapter, or the like, and supplies power to the entire HMD 1000. In addition, the power supply unit 170 includes a power switch that switches power on and power off according to a user's operation or other conditions. The communication unit 180 communicates with an information terminal such as a PC or a network such as a LAN or the Internet on the basis of the control of the CPU 150.

The touch recognition unit 190 recognizes a user's touch operation on a real object. The touch recognition unit 190 is implemented by software, for example, when the CPU 150 performs arithmetic processing for the captured video of the imaging unit 1020 on the basis of a touch recognition program stored in the memory 160. Alternatively, in a case where the touch recognition unit is implemented by a method of measuring a change in capacitance, the touch recognition unit is configured by a capacitance measuring meter or the like.

The HMD 1000 according to the present embodiment includes the optical prisms 115L, 115R, 117L, and 117R according to the above-described embodiment. Since these optical prisms have extremely small internal strain, the HMD 1000 can perform imaging and display with high image quality. Note that the arrangement, the number, and the like in mounting the optical prism according to the above-described embodiment on the HMD are not limited to the illustrated example of the HMD 1000, and can be appropriately changed.

### System Including Optical Device

A mixed reality system (MR system) including the above-described video see-through type HMD 1000 according to the present embodiment will be described with reference to FIG. 15B.

As illustrated in FIG. 15B, the MR system according to the present embodiment includes the HMD 1000 that is an example of a head mounted display device, a computer device 1103, and a controller 1102 that mediates between the HMD 1000 and the computer device 1103. The computer device 1103 generates an image of a mixed reality space (a space obtained by fusing a real space and a virtual space) to be displayed on the HMD 1000.

The HMD 1000 includes the imaging unit 1020 that captures an image of the real space, a sensor that measures (performs measurement processing for) position and orientation of the local device, and the display unit 1040 that displays the image of the mixed real space transmitted from an image processing device 104. The HMD 1000 also functions as a synchronization control device for the plurality of devices. The HMD 1000 transmits the captured image captured by the imaging unit and the position and orientation of the local device measured by the sensor to the controller 102. Further, the HMD 1000 receives the image of the mixed reality space generated by the computer device 1103 on the basis of the captured image and the position and orientation from the controller 1102 and displays the image on the display unit. As a result, the image of the mixed reality space is presented in front of the eyes of the user wearing the HMD 1000 on the head.

The HMD 1000 may operate with a power supply supplied from the controller 1102 or may operate with a power supply supplied from a battery included in the local device. That is, a method of supplying power to the HMD 1000 is not limited to a specific method. In FIG. 15B, the HMD 1000 and the controller 1102 are connected by wire. However, a connection form between the HMD 1000 and the controller 1102 is not limited to wire, and may be wireless or a combination of wireless and wire. That is, the connection form between the HMD 1000 and the controller 1102 is not limited to a specific connection form.

Next, the controller 1102 will be described. The controller 1102 performs various types of image processing (resolution conversion, color space conversion, distortion correction of an optical system of the imaging unit included in the HMD 1000, encoding, and the like) for the captured image transmitted from the HMD 1000. Then, the controller 1102 transmits the captured image subjected to the image processing and the position and orientation transmitted from the HMD 1000 to the computer device 1103. In addition, the controller 1102 performs similar image processing for the image of the mixed reality space transmitted from the computer device 1103 and transmits the image to the HMD 1000.

Next, the computer device 1103 will be described. The computer device 1103 obtains the position and orientation of the HMD 1000 (the position and orientation of the imaging unit included in the HMD 1000) on the basis of the captured image and the position and orientation received from the controller 1102, and generates an image of the virtual space viewed from a viewpoint having the obtained position and orientation. Then, the computer device 1103 generates a composite image (an image of the mixed reality space) of the image of the virtual space and the captured image transmitted from the HMD 1000 via the controller 1102, and transmits the generated composite image to the controller 1102. In the drawing, the computer device 1103 and the controller 1102 are separate devices, but the computer device 1103 and the controller 1102 may be integrated.

The MR system according to the present embodiment includes the HMD 1000 according to the above-described embodiment. Since the HMD 1000 includes the optical prism in which the internal strain is small and a weld is formed outside an optical effective range, imaging and display can be performed with high image quality. Therefore, the MR system according to the present embodiment can provide the user with a high-quality mixed reality space in which the real space and the virtual space are fused. Note that the method for mounting the HMD according to the above-described embodiment on the MR system is not limited to the example illustrated in FIG. 15B, and can be appropriately changed. Furthermore, the target for mounting the HMD according to the above-described embodiment is not limited to the MR system. For example, the system may be an augmented reality system (AR system), a virtual reality system (VR system), or other systems.

### Modifications

Note that the present technology is not limited to the above-described embodiments, and many modifications can be made within the technical idea of the present technology.

In the embodiment, the case where the molten resin M1 used in manufacturing the first molded part 11 and the molten resin M2 used in manufacturing the second molded part 12 are substantially the same material has been described, but the embodiment is not limited to this example, and the materials may be different. In this case, it is desirable to select the resin material of the first molded part 11 and the resin material of the second molded part 12 in consideration of compatibility.

In the embodiment, the optical prism 1 having the three optical surfaces has been described, but the optical element according to the embodiment is not limited to this example, and may be an optical element having at least one optical surface. For example, the optical element may be a thick optical lens having two optical surfaces or an optical element having four or more optical surfaces. In the case of the optical element having four or more optical surfaces, not all of the four surfaces need to be disposed in the second molded part 12, and at least three surfaces may be disposed in the second molded part 12. However, in consideration of shape accuracy of the optical surface, it is desirable to dispose all the optical surfaces in the second molded part 12 even in the case where there are four or more optical surfaces.

In the embodiment, the case where the distance between the first optical surface 21 and the first optical interface 601, the distance between the second optical surface 22 and the second optical interface 602, and the distance between the third optical surface 23 and the third optical interface 603 are 1.5 mm or more and 1.8 mm or less has been described. The embodiment of the present technology is not limited to the case, and the distance between the optical surface and the optical interface (that is, the thickness of the second molded part 12 in the portion where the optical surface is formed) is desirably 0.5 mm or more and 5 mm or less in consideration of the shape accuracy of the optical surface.

Note that the thickness of the second molded part in the portion under the optical surface is not necessarily the same in any optical surface. Further, the thickness of the second molded part in one optical surface is not necessarily uniform at any position. However, a ratio between a maximum value and a minimum value of the thickness of the second molded part in the optical surface is desirably suppressed to 2 or less in consideration of the shape accuracy of the optical surface. To make the thickness of the second molded part in the optical surface uniform, the shapes of the optical interface and the optical surface may be made similar to each other, but may not be made similar to each other. For example, the optical interface may be a spherical surface and the optical surface may be an aspherical surface, or the optical interface may be an aspherical surface and the optical surface may be a free-form surface.

The optical surface is not limited to a specific geometric shape, and a curved surface shape such as a spherical surface or an aspherical surface may be combined according to application of the optical element. For example, a three-sided prism in which the first optical surface has a free-form surface shape and the second optical surface and the third optical surface are flat surfaces may be adopted. Furthermore, the shape of the non-optical surface may be a flat surface, a curved surface, or a combination thereof.

In the optical element according to the embodiment, in order to sufficiently anneal the periphery of the first gate mark 51, the second gate 851 is disposed in the vicinity of the first gate mark when the second molded part is molded, and the periphery of the first gate mark can be heated while the injected molten resin M2 is at a high temperature. In the above-described embodiment, the first molded part is disposed in the second cavity such that the second gate is in a positional relationship facing the first gate mark across a partial space of the second cavity. As a result, the completed optical prism has a configuration in which the first gate mark of the first molded part is covered with the portion of the second molded part having the second gate mark formed by the second gate 851.

However, the relative position of the second gate with respect to the first gate mark can be changed, and the second gate mark may not necessarily be disposed immediately above or in the vicinity of the first gate mark, as long as the periphery of the first gate mark is sufficiently annealed by the injected molten resin M2. In this case, the second gate mark is formed at a position different from the position immediately above or in the vicinity of the first gate mark in the non-optical surface.

According to the disclosure of the present specification, in manufacturing the thick optical element including the first molded part and the second molded part, it is possible to suppress the internal strain generated around a specific portion of the first molded part in molding the first molded part using the first mold from remaining until after the second molded part is molded. Therefore, it is possible to provide a thick optical element having excellent optical characteristics.

Furthermore, the contents of disclosure in the present specification include not only contents described in the present specification but also all of the items which are understandable from the present specification and the drawings accompanying the present specification. Moreover, the contents of disclosure in the present specification include a complementary set of concepts described in the present specification. Thus, if, in the present specification, there is a description indicating that, for example, “A is B”, even when a description indicating that “A is not B” is omitted, the present specification can be said to disclose a description indicating that “A is not B”. This is because, in a case where there is a description indicating that “A is B”, taking into consideration a case where “A is not B” is a premise.

### Other Embodiments

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-075623, filed May 8, 2024, which is hereby incorporated by reference herein in its entirety.

What is claimed is:

1. An optical element comprising:
a first molded part made of resin; and
a second molded part made of resin and configured to cover at least a part of the first molded part, wherein
the first molded part has a recess,
the second molded part has a first resin part having an optical surface on an outer surface and a second resin part having a non-optical surface on an outer surface, and
a gate mark in molding the first molded part is disposed in the recess and covered with the second resin part.

2. The optical element according to claim 1, wherein
a gate mark in molding the second molded part is disposed in the second resin part.

3. The optical element according to claim 2, wherein
the gate mark in molding the first molded part is covered with a portion of the second molded part where the gate mark in molding the second molded part is disposed.

4. The optical element according to claim 1, wherein
the optical element has a protrusion, and the protrusion includes one or both of the first molded part and the second resin part.

5. The optical element according to claim 4, wherein
the protrusion is a portion supported by a device in a case where the optical element is mounted on the device.

6. The optical element according to claim 1, wherein
the optical surface has surface roughness Ra of less than 20 nm.

7. The optical element according to claim 1, wherein
a material of the first molded part and a material of the second molded part are substantially same.

8. The optical element according to claim 1, wherein
the optical element is a prism.

9. A method for manufacturing an optical element, the method comprising:
a step of injecting a molten resin from a first gate of a first mold provided with the first gate and a first cavity into the first cavity and solidifying the molten resin to form a first molded part having a recess in which a gate mark of the first gate is disposed; and
a step of disposing the first molded part in a second cavity of a second mold provided with a second gate and the second cavity, injecting a molten resin from the second gate into the second cavity and solidifying the molten resin to form a second molded part that covers at least a part of the first molded part, wherein
the second mold includes a first molding surface that forms at least one optical surface molded in the second molded part, and a second molding surface that forms at least one non-optical surface molded in the second molded part, and
in the step of forming the second molded part, the first molded part is disposed in the second cavity such that the gate mark of the first gate faces the second molding surface across a part of a space of the second cavity, and the molten resin is injected into the space.

10. The method for manufacturing an optical element according to claim 9, wherein
in the step of forming the second molded part, a portion including the gate mark of the first molded part is annealed by the molten resin injected into the second cavity.

11. The method for manufacturing an optical element according to claim 9, wherein
in the step of forming the second molded part, a temperature of the molten resin injected into the second cavity is higher than a glass transition point temperature of a resin constituting the first molded part.

12. The method for manufacturing an optical element according to claim 9, wherein
in the step of forming the second molded part, a temperature of the molten resin injected into the second cavity is higher than a melting point temperature of a resin constituting the first molded part.

13. The method for manufacturing an optical element according to claim 9, wherein
a material of the molten resin injected into the first cavity and a material of the molten resin injected into the second cavity are substantially same.

14. The method for manufacturing an optical element according to claim 9, wherein
the first molding surface of the second mold for molding the optical surface has surface roughness Ra of less than 20 nm.

15. The method for manufacturing an optical element according to claim 9, wherein
in the step of forming the second molded part, the first molded part is disposed in the second cavity such that the gate mark in molding the first molded part faces the second gate across a part of a space of the second cavity.

16. An optical device comprising:
the optical element according to claim 1; and
a support member configured to support the optical element.

17. The optical device according to claim 16, wherein
the optical element includes a protrusion, the protrusion is supported by the support member, and the protrusion includes one or both of the first molded part and the second resin part.

18. The optical device according to claim 16, comprising:
an optical unit for a left eye and a right eye, each optical unit including a display unit having the optical element.

19. A system comprising:
the optical device according to claim 16; and
a computer device configured to generate an image.
